(19) United States
(12) Patent Application Publication
(10) Pub. No.: US 2006/0194572 A1
(43) Pub. Date: Aug. 31, 2006

(54) Wireless interactive property advertising system and methods

(75) Inventors: Dean Fresonke, Windermere, FL (US); Jeffrey Scott Stewart, Oviedo, FL (US); Ronald Dale Willett, Orlando, FL (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: ClearSky Mobile Media, Inc., Orlando, FL (US)

(21) Appl. No.: 11/364,988

(22) Filed: Feb. 28, 2006

Related U.S. Application Data
(60) Provisional application No. 60/657,167, filed on Feb. 28, 2005.

(51) Int. Cl. H04Q 7/22

(52) U.S. Cl. 455/414.1

(57) ABSTRACT

A system for providing property information about a property over a wireless network to an interested party having a mobile device, comprising: (a) an advertisement associated with the property, the advertisement having a shortcode and a keyword, and (b) a networked computer system having a property database containing property information for the property; the property information being retrievable from the property database based on the shortcode and the keyword. In operation, the interested party requests the property information about the property by sending a message with the shortcode and the keyword over the wireless network using the mobile device and, in response, the networked computer system retrieves the property information about the property associated with the shortcode and the keyword from the property database and transmits the property information to the mobile device of the interested party.

### CROSS-REFERENCE TO RELATED APPLICATION

This application claims the benefit of and priority to U.S. Provisional Patent Application No. 60/657,167, filed Feb. 28, 2005, entitled “METHOD AND APPARATUS FOR A WIRELESS INTERACTIVE REAL ESTATE ADVERTISING” by Dean Fresonke, Ron Willett, and Scott Stewart, which is incorporated herein by reference in its entirety.

### FIELD OF THE INVENTION

The invention pertains to an information delivery system for use in a wireless telecommunications network. More particularly, the invention enables information delivery and interactive messaging capabilities for use by consumers and advertisers in the real estate market and in any other property markets for sale or rental of any assets.

### BACKGROUND OF THE INVENTION

Sale or rental transactions involving any type of property, such as real estate, automobiles, or other personalty or assets, requires matching the property or asset with a buyer or renter. Sales and rentals are based on the needs, availability, and affordability of the relevant property. For the seller or lessor, the dissemination of information relating to properties for sale or rent is crucial to her success. In order to speed up the sale or rental of the property, owners of the property need to increase the exposure of the property to as many interested parties as possible and as quickly, easily, and cheaply as possible. Similarly, in order to make an informed and reasoned decision, buyers or renters need to have ready access to as much information as possible relating to potential properties for sale or rent. Therefore, getting property information to as many people and as quickly as possible is very important.

Traditionally, property information is publicized by the advertisement on local newspapers, print ads in magazines, billboards, signs posted on the properties, entries maintained in multiple listing services, on websites, or a combination of these methods.

When a buyer or renter is looking for a property or asset for sale or for rent, he often finds himself in a situation where he finds a property for sale but does not have a good way of remembering or recording information relating to the property, such as location, pricing, or contact information for obtaining further information about the property or asset. The buyer or renter typically can only make a brief visual assessment of the property. There is no detailed information immediately available for the property, and it may be necessary for the interested party to review the property again (which may or may not happen) once additional information is obtained. It is also difficult for the buyer or renter to make an immediate comparison among potential properties or assets of interest. To save time and effort, it is beneficial for the buyer or renter to have an easy, quick and inexpensive (or free) way to retrieve information about a property and to be able to store such information electronically for later retrieval, perhaps, for comparison purposes. Since shopping for a property is often conducted away from the home or office, the most appropriate retrieval and storage device is one that is mobile and battery powered, such as a PDA or cell phone.

Short Message Service (hereinafter “SMS”), a service from wireless communication service providers, provides enabling technology for implementing a new system for distributing information on properties or other assets for sale or rent. SMS allows consumers to send text messages from their mobile devices to a shortened four or five-digit telephone number (“shortcode”) following instructions found in signs, printed advertisements, and other marketing materials and to receive back one or more text messages, URLs for accessing web-based information, and/or binary downloads, the content of which corresponds to the keywords inside the body of the original message. A computer system stores information relating to all registered properties in its database. The computer system is able to receive a shortcode from a mobile device through wireless service providers and then to transmit information relating to a particular property back to the mobile device that submitted the text message.

Existing systems on the market do not use SMS or other wireless data technologies. With existing systems, consumers access certain pre-recorded messages describing the features of a property by dialing a telephone number listed on a sign, printed advertisement, radio commercial, or other advertising medium. Alternatively, a consumer is able to access an ID code through a webpage or perform a look up from an online database using a computer.

The above mentioned methods and systems have many problems and disadvantages, including:
Existing products have yet to combine the use of SMS messages, WAP push, email or other wireless content delivery methods with real estate signs or other real estate advertising methods or other advertisements for property or assets, such as display ads, to deliver property-specific or asset-specific information upon request of a potential buyer or renter.
Existing products do not employ a unique, easy to remember, three or more digit sequence of alphanumeric characters displayed on a real estate sign, in real estate marketing literature, or other advertisement, which, when sent to a specific shortcode in an SMS message from a consumer's mobile device, allows an electronic messaging system correctly to extract predefined information about the property and return it to the consumer's mobile device.
Multi-media messaging service (“MMS”) messages containing text and/or video related to a property or asset are not available in existing systems.
Existing advertising systems do not have the ability to allow consumers to see pictures and/or video clips and/or get additional textual information about a property using a URL embedded in an SMS message with the Internet browsing capability of mobile devices.
Existing advertising systems do not use SMS, WAP Push, email messages or other wireless alerting mechanisms to alert advertisers that a consumer has requested information about a property or that a consumer has requested someone contact him/her about a property or asset as follow up.
Existing advertising systems do not provide Internet browser access to an electronic messaging system database to allow a salesperson, broker or property owner readily to modify, update, change or adapt the content returned to the consumer regarding a request for information.
Existing advertising systems do not allow the establishment of a real-time SMS, MMS, email or other wireless electronic message conversation between the consumer interested in a property or asset and the salesperson, broker or property owner.
Existing advertising systems do not allow additional information to be delivered to the consumer using one or more SMS messages, MMS messages or through an Internet browser on a mobile device based on a consumer replying to an original electronic messaging system-generated message with keywords such as “schools”, “Churches”, “utilities”, and “financing”.
Existing advertising systems do not provide an historical record of wireless messaging system inquiries about a property accumulated over time in the form of electronic or printed reports.
Existing advertising systems are unable to access real estate multiple listing services to extract descriptive information and photographs and convert them for use in wireless environments.

Therefore, a number of unaddressed needs exist in the industry to address the aforementioned deficiencies and inadequacies.

### SUMMARY OF THE INVENTION

The invention enables brokers, agents, related real estate-oriented individuals, and property owners (“advertisers”), who are employing any combination of indoor or outdoor signage, magazine, newspaper and other static display advertising a way to interact with potential purchasers or renters using, either individually or in any combination, SMS, MMS, WAP Push, email, Internet browsing, and video streaming capabilities of a mobile device. The invention contains a method for advertisers to input and update information as well as to receive alerts and reports on consumer activity.

In one aspect of the invention, a system for providing property information about a property over a wireless network to an interested party having a mobile device, comprises: (i) an advertisement associated with the property, the advertisement having a shortcode and a keyword; and (ii) a networked computer system having a property database containing property information for the property; the property information being retrievable from the property database based on the shortcode and the keyword, wherein, in operation, the interested party requests the property information about the property by sending a message with the shortcode and the keyword over the wireless network using the mobile device and, in response, the networked computer system retrieves the property information about the property associated with the shortcode and the keyword from the property database and transmits the property information to the mobile device of the interested party.

In one feature, the networked computer system further comprises an electronic messaging platform having (a) a mobile client interface for establishing communications with the mobile device and (b) a message generator for generating at least one message having the property information for transmission to the mobile device.

In another feature, the networked computer system further comprises an administration platform having a web client interface and a web server for receiving property information for storage in the property database.

In some features of the invention, the property information includes a URL link to an associated website having further information about the property. In other features, the property information includes information extracted from a multiple listing service. In yet further features, the keyword comprises a unique, three or more digit sequence of alphanumeric characters.

In another feature, the message identifies additional ways to obtain further information about the property.

In yet a further feature, the interested party requests further information by sending a reply to the message.

In a different feature, the networked computer system further comprises: (i) an electronic messaging platform having (a) a mobile client interface for establishing communications with the mobile device and (b) a message generator for generating at least one message having the property information for transmission to the mobile device; (ii) an administration platform having a web client interface and a web server for receiving property information for storage in the property database; and (iii) a central processing system in communication with the property database, the electronic messaging platform, and the administration platform.

In another feature, the administration platform enables an advertiser of the property to register, enter, modify, remove and retrieve property information from the property database.

In yet a further feature, the message is in an electronic format, such as SMS, MMS, WAP Push, WML, emails, and HTML pages.

In a second aspect of the present invention, a method for providing property information about a property over a wireless network to an interested party having a mobile device, comprises the steps of: (i) associating an advertisement with the property, the advertisement including a shortcode and a keyword; (ii) storing property information about the property in a database; (iii) associating the stored property information with the shortcode and the keyword; (iv) receiving a message from the mobile device, the message including the shortcode and the keyword; (iv) retrieving the property information associated with the shortcode and the keyword from the database; and (v) transmitting the property information to the interested party's mobile device through the wireless network.

In a feature of the second aspect, the method comprises the step of receiving property information from an advertiser associated with the property.

In other features of the second aspect, the keyword comprises a unique, three or more digit sequence of alphanumeric characters, the transmitting step further comprises the steps of providing the property information in an electronic format, the electronic format includes one of SMS, MMS, WAP Push, WML, emails, and HTML pages, the transmitting step further comprises the step of providing a URL link to an associated website having further information about the property, the transmitting step further comprises the step of identifying additional ways to obtain further information about the property, and the transmitting step further comprises the step of providing property information extracted from a multiple listing service.

These and other aspects and features of the invention will become apparent from the following description of the preferred embodiment(s) taken in conjunction with the following drawings and claims, although variations and modifications therein may be affected without departing from the spirit and scope of the novel concepts of the disclosure.

### BRIEF DESCRIPTION OF THE DRAWINGS

Further features and benefits of the invention will be apparent from a detailed description of preferred embodiments thereof taken in conjunction with the following drawings, wherein similar elements are referred to with similar reference numbers, and wherein:

FIG. 1 is a high level overview of an exemplary system for wireless interactive property advertising (WIPA) that embodies aspects of the invention.

FIG. 2 is a more detailed information flow of an exemplary system for wireless interactive property advertising (WIPA) according to one embodiment of the invention.

FIG. 3 is a flowchart of how an advertiser typically interacts with the system.

FIG. 4 is a flowchart of how a consumer typically interacts with the system.

FIG. 5 shows an exemplary message to be sent and an exemplary SMS message received in response to the SMS message sent according to one embodiment of the invention.

FIG. 6 is an example of a Web-based order form that an advertiser uses to configure information about a property using the invention.

FIG. 7 is an example of a Web-based payment form that an advertiser uses to sign up a property using the invention.

### DETAILED DESCRIPTION OF THE INVENTION

Prior to a detailed description of the invention(s), the following definitions are provided as an aid to understanding the subject matter and terminology of aspects of the invention(s), and not necessarily limiting of the invention(s), which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. A capitalized term within the glossary usually indicates that the capitalized term has a separate definition within the glossary. However, the capitalization or lack thereof within the remainder of this document is not intended to be necessarily limiting unless the context clearly indicates that such limitation is intended.

### EXEMPLARY DEFINITIONS/GLOSSARY

DBMS: database management system.

Interested Party: a person or a group of people interested in buying, selling, leasing or renting a property.

Mobile devices: any devices used for communication over wireless communication networks, such as a cellular phone, a walkie-talkie, a personal digital assistant (PDA), a pager, a smart phone, or any combinations thereof.

LANs: local-area networks, the computers are geographically close together (that is, in the same building).

MLS: Multiple Listings Service.

Protocol: A protocol defines a common set of rules and signals that computers on the network use to communicate. One of the most popular protocols for LANs is called Ethernet. Another popular LAN protocol for PCs is the IBM token-ring network.

WANs: wide-area networks, the computers are farther apart and are connected by telephone lines or radio waves.

CANs: campus-area networks, the computers are within a limited geographic area, such as a campus or military base.

MANs: metropolitan-area networks, a data network designed for a town or city.

HANs: home-area networks, a network contained within a user's home that connects a person's digital devices.

Transaction: a transaction in the property exchanges include the buying, the selling, renting of a property.

CDMA: Code division multiple access (CDMA) is a form of multiplexing and a method of multiple access that does not divide up the channel by time, or frequency, but instead encodes data with a certain code associated with a channel and uses the constructive interference properties of the signal medium to perform the multiplexing. CDMA also refers to digital cellular telephony systems that make use of this multiple access scheme.

GSM: Global System for Mobile Communications is the most popular standard for mobile phones in the world. Both signaling and speech channels of a GSM mobile phone are digital. It is considered a second generation (2G) mobile phone system.

GRPS: General Packet Radio Service is a mobile data service available to users of GSM mobile devices. It is often described as “2.5G”, that is, a technology between the second (2G) and third (3G) generations of mobile telephony.

MMS: Multimedia Message Service is a service available on most 2.5G cellular networks which enables two-way transmission between handsets of multi-media messages including text, pictures, audio and video.

SMS: Short Message Service is a service available on most digital mobile devices that permits the sending of short messages (also known as text messages, messages, or more colloquially SMSs, texts or even txts) between mobile devices, other handheld devices.

Property: assets belong to someone. In this application, a property comprises, but not limited to, real estate and other assets. The real estate includes houses, townhouses, apartments, condominiums, vacation homes, timeshare, retail spaces, and business offices etc. Other assets include automobile vehicles, motorcycles, boats, furniture and other personal belongings.

UI: User Interface. Typically means a software Application with which a User interacts for purposes of entering information, obtaining information, or causing functions of an associated system to execute.

WAP Push: A wireless messaging technique which enables a messaging platform to start a WAP browsing session on a mobile handset by sending the handset a specially formatted alert message.

### System Description

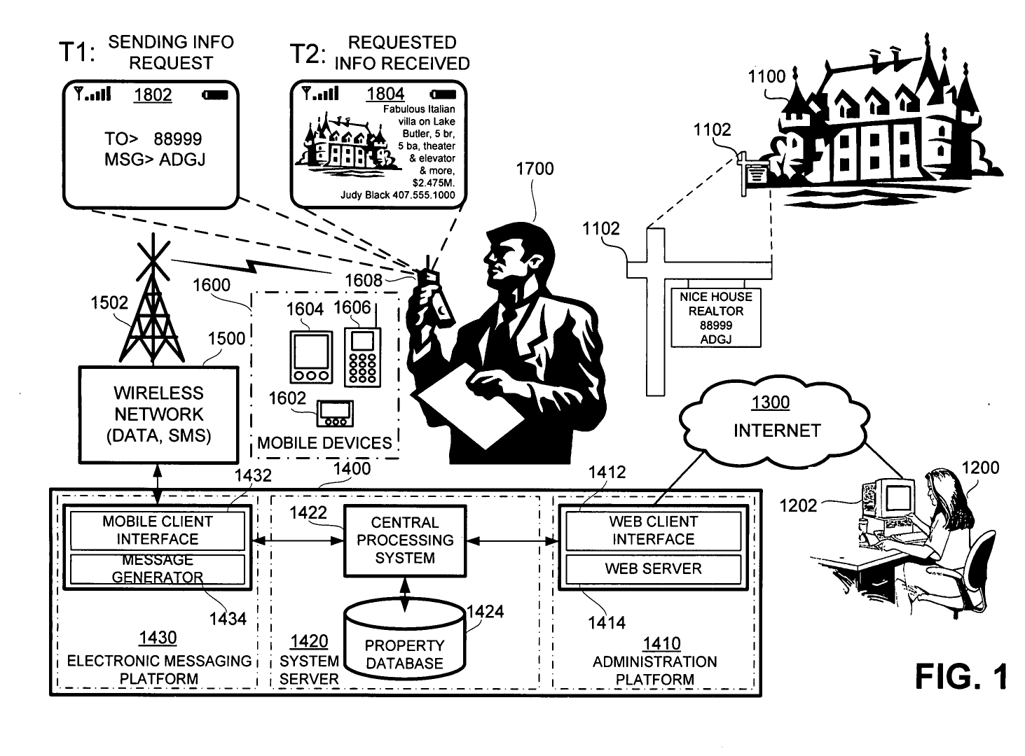

FIG. 1 shows a high level overview of an exemplary system for wireless interactive property advertising (WIPA) that embodies aspects of the invention. The WIPA system comprises a networked computer system 1400, the internet 1300 or other network, a plurality of wireless service providers 1500, a plurality of mobile devices 1600, and a plurality of computers 1202 connected to the internet 1300.

The networked computer system 1400 comprises three major components: (i) an Administration Platform (AP) 1410 having a web client interface 1412 and a web server 1414; (ii) a system server (SS) 1420 having a central processing system 1422 and a property database 1424; and (iii) an Electronic Messaging Platform (EMP) 1430 having a mobile client interface 1432 and a message generator 1434.

The AP 1410 allows an advertiser, such as a property owner, broker, or salesperson, to sign up, pay, configure, and administer a wireless interactive real estate advertising campaign. The AP 1410 is preferably accessed by an advertiser 1200, having a computer 1202 with a conventional Web browser for access to the AP 1410 through the Internet 1300. Other conventional means for accessing the AP 1410, such as using an application loaded on a hand-held device that allows uploading and configuring of content, can also be used by the advertiser.

An advertiser is able to upload information about a particular property 1100. Such information may be configured as an SMS message, containing text, as well as MMS messages, containing any combination of text, pictures, video clips and audio clips. The AP 1410 is also capable of translating property information including text, pictures and video clips into web pages capable of displaying on mobile handsets, including pages formatted using WML and HTML and configured to render correctly based on the type of handset accessing the web server 1414 within the administration platform 1410.

The System Server 1420 is designed to store registered property information in the property database 1424, to issue a unique keyword for each registered property, to process information request from the mobile client interface 1432, and to respond the information request with information retrieved from the property database 1424.

The electronic messaging platform 1430 is used as a bridge between the system server 1420 and the wireless networks 1500. The electronic messaging platform 1430 is capable of receiving SMS messages from wireless networks, analyzing the characters within the SMS message, selecting the appropriate content based on the match and returning content in one or more forms, including but not limited to one or more SMS messages. When the mobile client interface 1432 receives an information request from a potential client 1700, the mobile client interface 1432 passes the information request to the system server 1420 for information retrieval. When the mobile client interface 1432 receives information back from the system server 1420, the mobile client interface 1432 forwards the retrieved information to the designated client 1700. The platform is capable of supporting standard messaging formats including SMS, MMS, WAP Push, IP, and MPEG4. The message generator 1434 is used to generate SMS messages when the outgoing message is in SMS format.

Wireless Network 1500 is a radio network, operated and maintained by a third party, allowing the transmission of SMS messages with the optional capability to transmit MMS messages, WAP Push messages, support IP packet traffic for web browsing and for either downloading or streaming video content. The network 1500 supports the routing of SMS messages to a particular IP address when the messages are addressed on the handset to a unique number of nine or less digits (a “shortcode”). The wireless network 1500 is also capable of receiving SMS messages from a platform external to the network—most typically using SMPP or SMTP communications protocols and then delivering the message based on the phone number of the mobile device which is included in the inbound message. The wireless network 1500 includes at least one wireless service provider that is able to send and receive SMS messages and, preferably, also capable of sending and receiving MMS, WML, emails, HTML pages or other formats.

A mobile device 1608 is a type of wireless, digital telecommunication device in which a subscriber has a radio frequency connection between the device and an antenna 1502 within the Wireless Network 1500. A mobile device 1600 can be any one of the following specific types of devices, including a cellular phone 1606, a pager 1602, a personal digital assistant (PDA) or smart phones 1604, such as a TREO or Blackberry with email service capability and internet accessibility. These mobile devices can be CDMA, GSM, GRPS or any digital wireless connection devices. The features of the mobile device 1608 include that of a text-messaging terminal using the SMS protocol, which allows the user 1700 to type in a message of approximately 150 characters. Likewise the device 1608 is configured to receive a message of approximately 150 characters. The invention preferably uses the SMS protocol to communicate with an electronic Messaging Server and, optionally, MMS feature, WAP Push feature, Internet browsing feature, digital camera feature, video player feature, and/or video display feature. Once the signal from the Mobile device 1608 reaches the antenna 1502, the remainder of the connection to the end point of the communications link is accomplished using landline connection and protocols. As will become apparent herein, the user 1700 addresses the SMS message to the server by using a nine-digit or less “shortcode” number as the “to” address. The Wireless Network interprets the shortcode and routes the message to the electronic messaging platform using industry standard protocol SMPP or SMTP.

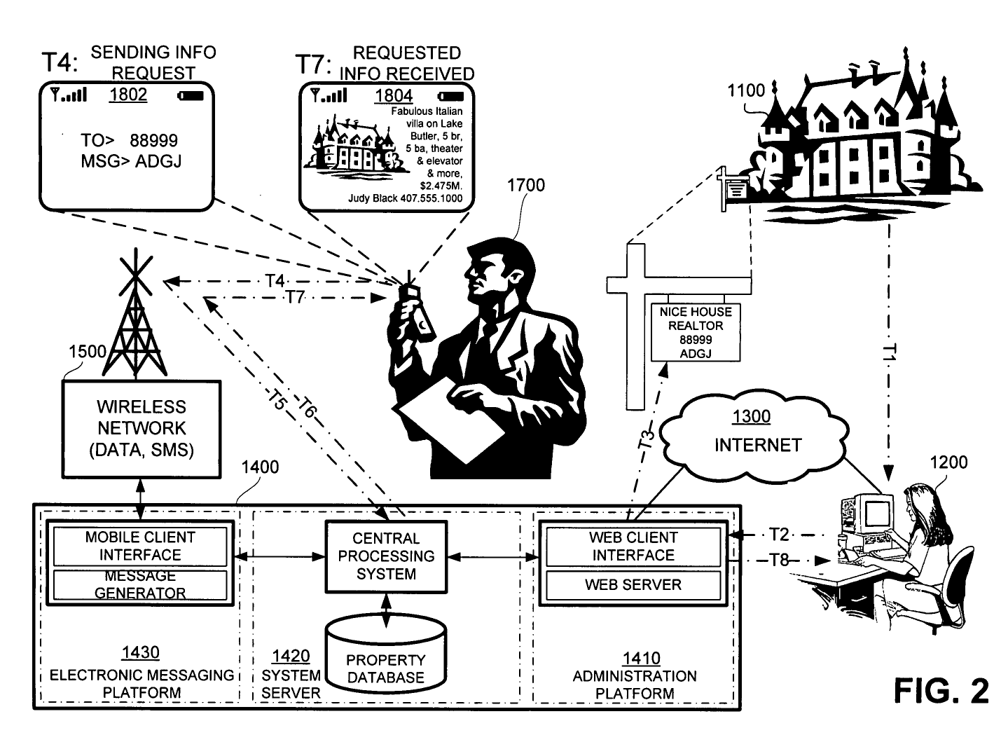

As shown in FIG. 2, a more detailed information flow of an exemplary system for wireless interactive property advertising (WIPA) is presented according to one embodiment of the invention. In FIG. 2, Tx represents the time sequence of steps or events that take place, with T1 being the earliest step or event and T7 being the last.

At T1, the advertiser 1200 collects or writes relevant information about the property 1100 and enters such information into her computer.

At T2, the advertiser 1200 uses her computer to upload property information relevant to the property 1100 through the internet 1300, through the AP 1400, and into the property database 1420. If this is an initial communication with the system server 1420, the advertiser first registers the property and pays for the advertising service through the web client interface. The server system 1420 assigns a unique shortcode (e.g., 88999) and a keyword (e.g., ADGJ) to the property 1100.

At T3, the advertiser 1200 puts the assigned, unique shortcode 88999 and keyword ADGJ onto an advertisement. The advertisement can be a yard sign, billboard, print ad, radio ad, or any type consumer oriented advertisement.

At T4, a person (an interested party) 1700 sees the advertisement and if interested in the property 1100, he sends an SMS message 1802 to the shortcode with the keyword ADGJ as the body of the SMS message.

At T5, the relevant wireless service provider in the network 1500 receives the SMS message from the interested party's mobile device and forwards the message to the mobile client interface where the SMS is further passed to the system server 1420. The system server 1420 analyses the SMS message, identifies the property based on the shortcode and keyword pair, and retrieves the property information from the property database.

At T6, the system server 1420 forwards the retrieved information corresponding to the shortcode and keyword pair to the electronic message platform 1430. The message generator generates one or more SMS messages based on the length of the original description of the property 1100. Then the SMS message is sent to the wireless service provider 1500 through the mobile client interface for transmission.

At T7, the interested party 1700 receives one or more SMS messages showing additional information relevant to the property 1100. This message may include a brief description of the property, further contact information, the price, etc. The message may further include pictures, video clips, MMS, WML, emails, URL of further information, HTML pages or other formats.

At T8, networked computer system 1400 provides an alert or notification back to the advertiser 1200 regarding the request for information by the potential consumer 1700 regarding the property 1100. Such notification contains, for example, the property address, the mobile device number of the consumer making the inquiry, and the time the inquiry occurred. Depending upon how the advertiser 1200 has requested to be notified, such notification may be by facsimile, email, text message, pager, voice mail, regular mail of a written report, posting of such information on the web client interface 1412 or other web page associated with the computer network system or similar methods of electronic or paper notifications that are known to those skilled in the art. Preferably, such notification would be in real time or near real time so that the advertiser could quickly respond to or contact the potential customer 1700, which could enhance the prospects for sale or rental of the property.

The process from T1 through T8 is only one illustration of the possible steps that can be performed as part of the communication. Further contacts between the interest party 1700 and the advertiser 1200 are possible after step T8, since at T7, the basic communication channel has been opened. The interested party 1700 can contact the advertiser 1200 to request a showing or to request further specific or different information. In addition, the advertiser 1200 now has an electronic record of the request for information from the interested party 1700; thus, the advertiser is able to contact the interested party 1700, by communicating further with the mobile device, if desired or necessary.

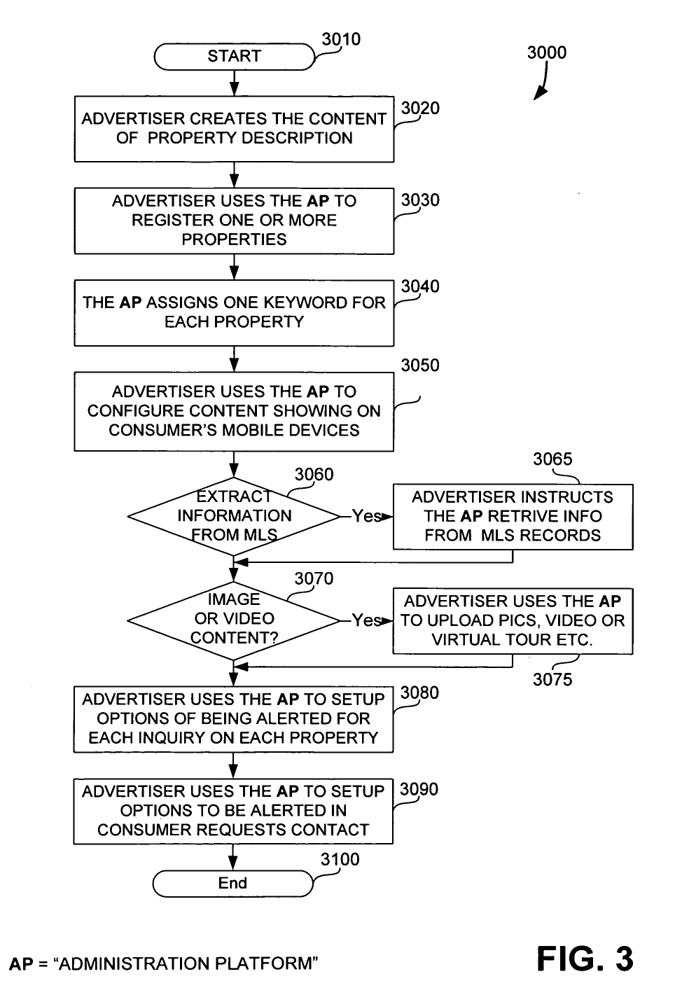

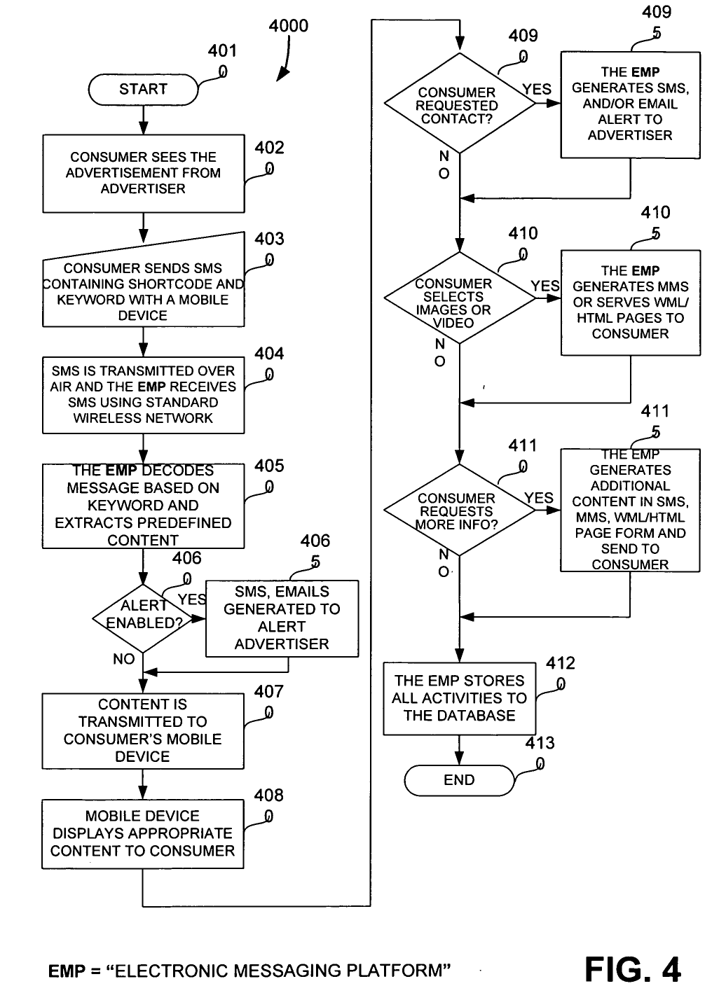

Now referring to FIGS. 3 and 4, the invention serves two different groups of people: (i) advertisers and (ii) potential customers or renter of the property being advertised by the advertiser, respectively. The system is first used by the advertiser to configure the information on a property and to configure how the advertiser will be alerted when the consumer is using the invention.

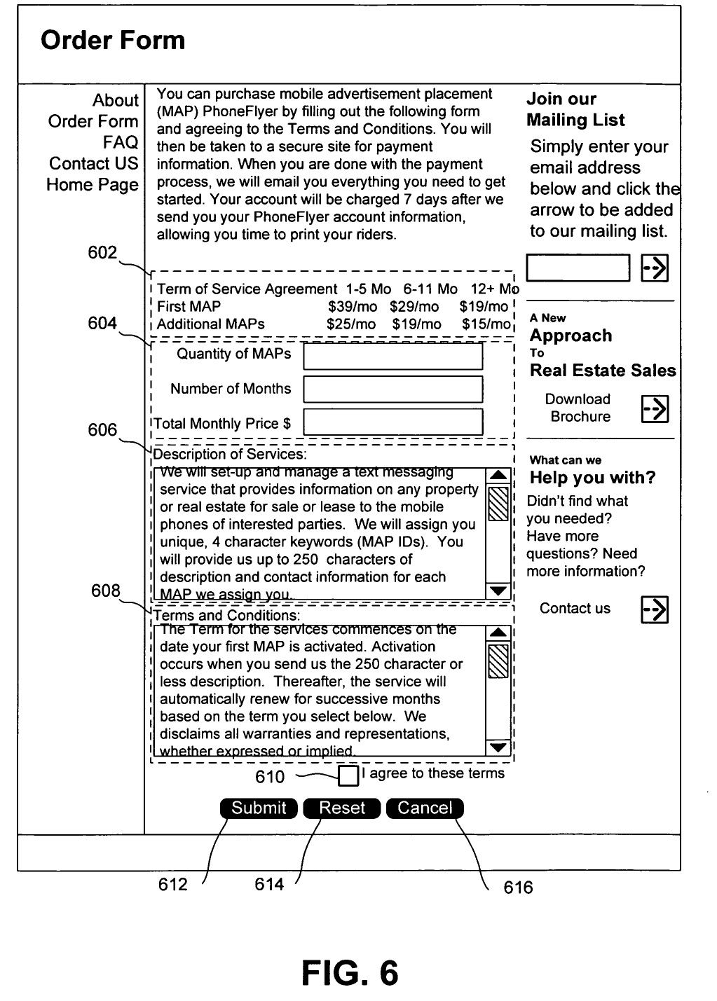

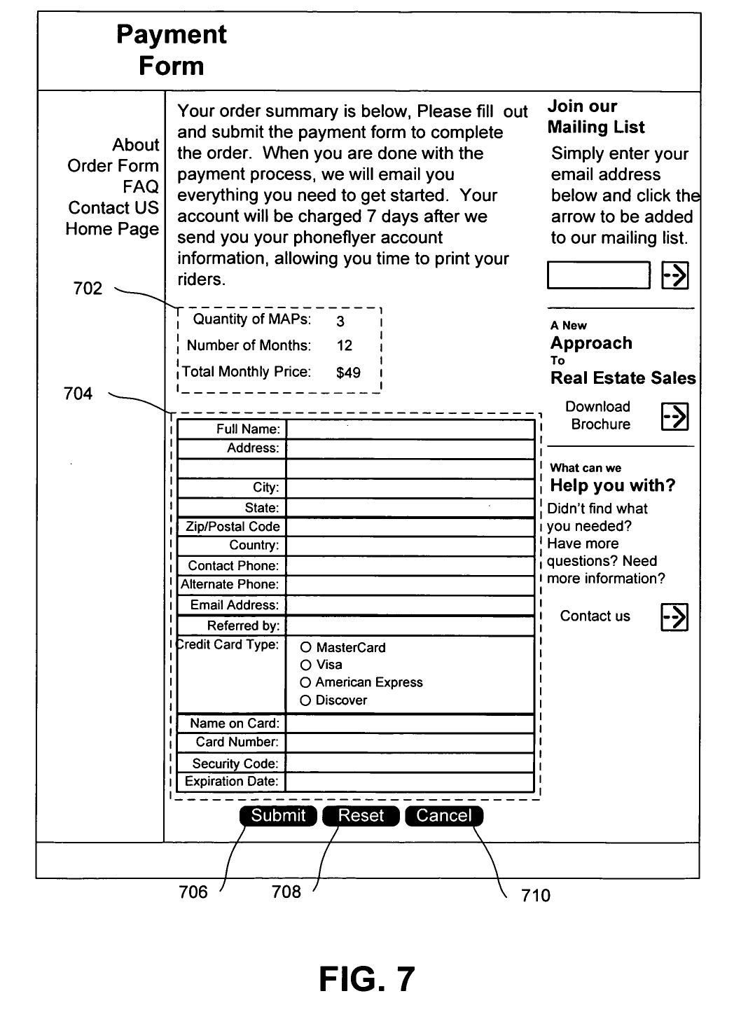

FIG. 3 is a flow chart 3000 that shows how the system interacts with the advertiser. The advertiser is able to configure one or more properties that he or she wishes to market using the system. The advertiser accesses the WIPA system, using a web browser on a computer, directed to a web site designated by the inventors. At the website, the advertiser fills in forms to purchase the interactive wireless marketing service (an example of such a form is shown in FIG. 6). The advertiser then provides payment information (as shown in FIG. 7).

Still referring to FIG. 3, after the start 3010, an advertiser creates the content of the advertisement of a property for sale or rent at step 3020. In step 3030, the advertiser accesses the WIPA system through its administration platform to sign up for wireless interactive property advertisement service for one or more properties. The WIPA system assigns a keyword for each property registered at step 3040.

Once the basic account information is entered along with the number of properties involved, the WIPA system generates a unique keyword consisting of three or more alphanumeric digits for each property. To the advertiser and consumer, these keywords are referred to as Mobile Advertisement Placements (MAPs). Every property in the system is associated with a unique keyword MAP. A shortened table of such MAP keywords is illustrated in Table 1.

TABLE 1

| Examples of | |
|---|---|
| MAP | Example of Property |
| adgj | 800 West Second Avenue, |
| | Windermere, Florida |
| ggh | 56 East Pine Street, |
| | Orlando, Florida |
| jhtst | 5127 Latrobe Avenue, |
| | Orlando, Florida |

As was shown in FIG. 1, an advertisement such as a yard sign provides the potential purchaser or renter with written and/or graphical instructions on how to obtain more information about the property using his/her Mobile device. Each advertisement for a given property displays the MAP keyword. The same keyword can be used in many different types of advertisements for one particular property; however, no two properties share the same keyword.

The advertiser then accesses the administration platform to configure the content for display on the potential customer's mobile device as shown in step 3050. During the configuration process, the advertiser determines what he or she wants the consumers to see on their mobile devices. The most basic option supported by the invention is a message consisting of approximately 130 characters, which the system delivers to the consumer's phone using SMS. The system, helps the advertiser compose the message by limiting the amount of information he or she can insert and then providing the opportunity to edit or modify descriptive text.

In order to get around word count restrictions, two or more SMS messages can be associated with a particular property, thereby allowing descriptive text of 260 or more characters, which the system delivers as SMS text messages in rapid succession. Another option available to an advertiser is to allow the advertiser to include an inquiry within the message text of property information, such inquiry asking whether the potential purchaser or renter wishes to be contacted by the advertiser immediately through a call or follow-up SMS message. When the consumer receives this prompt as part of the description and responds in the affirmative, an alert is routed to the advertiser for response.

In step 3060, the administration platform offers an option for the advertiser to access information from multiple listing services (MLS) databases and to extract the existing listing information, such as the photograph(s), to create the description of the property in a more expeditious and consistent manner. For property or assets other than real estate, information can be retrieved from other, relevant databases or resources of information. If the advertiser decides to extract information from the MLS or other resources, the advertiser may supplement the existing information from the MLS or other information sources, as shown in step 3065.

In step 3070, the administration platform offers the advertiser the option to use images as part of the description. At step 3075, the WIPA system allows the advertiser to upload images and descriptive text to accompany each image. The WIPA system automatically formats the images and generates predefined WML and HTML web pages containing such information as well as predefined MMS messages in SMIL document format. The WIPA system also allows the upload of video clips and descriptive text to accompany each clip. The WIPA system automatically formats the clips to be compatible with a variety of Mobile devices.

The information regarding the property is stored in the property database of the system server. Once there, the WIPA system is then ready to begin providing the property information to consumers upon request. The advertiser is able to place the MAP keyword into advertisements or have it printed on a sign for display on or near the property. If, at some point in the future, the advertiser wants to advertise a different property, the same keyword can be used for the new property. The WIPA system allows the advertiser readily to modify, update, change or adapt the property information associated with the property simply using a desktop computer equipped with an Internet connection and browser or by using a mobile device loaded with a special application. In addition the WIPA system allows the advertiser to turn on or off alerting herself about inquiries and to select the method or methods of such alerting including SMS, MMS, and email.

During the setup process for each property in step 3080, the advertiser is able to request to be alerted whenever anyone inquires about the property. The alert or notification contains the property address, the mobile device number of the consumer making the inquiry, and the time the inquiry occurred. The WIPA system also allows the advertiser to define the method of being alerted. The alert methods preferably include email, SMS, and similar methods. The advertiser enters her email address for email delivery, her mobile device number and wireless carrier with which she has service for SMS delivery. The advertiser is able to configure different alerting methods for each different type of alert. It is also possible for the alert or notification to be sent to the advertiser by facsimile, email, text message, voice mail, pager, regular mail of a written report or alert, posting of such information on the web client interface or other web page associated with the computer network system, and similar known methods of sending alerts or reports electronically or in paper format.

In step 3090, the advertiser is also able to request to be alerted whenever a potential purchaser or renter requests to be contacted after an initial inquiry about the property. This alert preferably contains the property address, the mobile device number of the consumer making the inquiry, and the time the inquiry occurred. The WIPA system allows the advertiser to define the method of being alerted or notified when customer contact is requested. If the interested customer specified a method of contact, the advertiser can respond to the request immediately after the request is received. A back up alert method may be configured here if the first method is not working at the time. The advertiser may also choose to be alerted in a combination of several alert methods. The configuration process ends in step 3100.

Referring now to FIG. 4, a flowchart 4000 of a typical interaction a consumer has with the WIPA system is shown according to one embodiment of the invention. The process starts at the step 4010. Upon seeing a display advertisement with a shortcode and a MAP keyword (in step 4020), and if the customer is interested in the property, he enters the shortcode as the SMS message destination number and enters the MAP keyword as a message body into his mobile device and sends an SMS message to the advertiser, as shown in step 4030. The wireless network transmits the message over the air and then routes it to the Electronic Messaging Platform (EMP) of the WIPA system over landline as show in step 4040. The EMP analyzes the body of the message to determine the MAP keyword and uses the MAP keyword to perform a database lookup to retrieve the related information about the property specified by the MAP keyword, as shown in step 4050.

In step 4060, the WIPA system checks the advertiser's configuration. If the advertiser has enabled alerts, then the Electronic Messaging Platform of the WIPA system notifies the advertiser with SMS and/or emails, as shown in 4065. These two steps 4060 and 4065 can be placed in any other later locations of the flowchart 4000, as well.

In its simplest incarnation, the WIPA system returns a single SMS message to the consumer, as shown in step 4070. Configurations involving more than one SMS message look similar; however, the consumer will receive multiple SMS messages as quickly as the Wireless Network is able to deliver them.

In step 4080, the consumer's mobile device displays the received information about the property he is interested in. In the step 4090, the WIPA system checks to see if the customer has made a follow-up request that the advertiser contact him. If so, the EMP generates SMS and/or email to notify the advertiser to contact the customer with customer's contact information, such as address, phone number or mobile phone number, or the like, in step 4095.

The EMP delivers pictures or video content in a number of ways. The SMS message preferably contains a URL, which links back to the Web server contained within the EMP. The URL is uniquely identified for the property by the MAP keyword that is embedded into the URL. When the consumer selects this link inside the text message in step 4100, many models of mobile devices will launch a WML or HTML browser built into the mobile device firmware and attempt to access the site. The EMP detects which type of HTML or WML browser is requesting information and from the keyword in the URL, serves up the appropriate Web pages for the property as shown in step 4105. These Web pages are able to have any combination of text, pictures and video and can be configured to prompt the consumer to request additional information about schools, churches or other geographic information as well as providing a mechanism for the consumer to request the advertiser to contact him or her.

In the step 4110, if the WIPA system receives a request from the customer, the EMP generates additional content in SMS, WML/HTML pages, or any combination of these message forms. The electronic messaging platform can also deliver picture or video information as an MMS message. The MMS message contains a combination of images, text, audio and video. For any method of delivery, video may actually be downloaded as a clip or it may be a URL link to a video clip stored on a Web server which, when selected, starts a video stream down to the Mobile device.

The communication between the advertiser and the potential customer does not stop here. More communication is possible if both parties have the mutual interests to continue the communication. For example, if the potential customer is interested in further information about “church”, “schools”, “utilities”, “communities” or “financing,” he can send back such keywords and the advertiser can send back related information in response to these keywords. Other real-time communication between the two parties is also possible either through SMS messaging or mobile/landline phone calls.

Once the consumer interaction is completed in step 4120, all activities and the time they occurred are stored in the property database of the WIPA system server. The WIPA system can generate reports or statistics of any or all activities. The reports enable the advertiser to determine the activity occurring on her properties and also enable the system administrators to determine the amount of activity on the WIPA system. The WIPA system can provide an historical record of SMS message inquiries about a property accumulated over time in the form of electronic or printed reports. The interactive process ends in the step 4130.

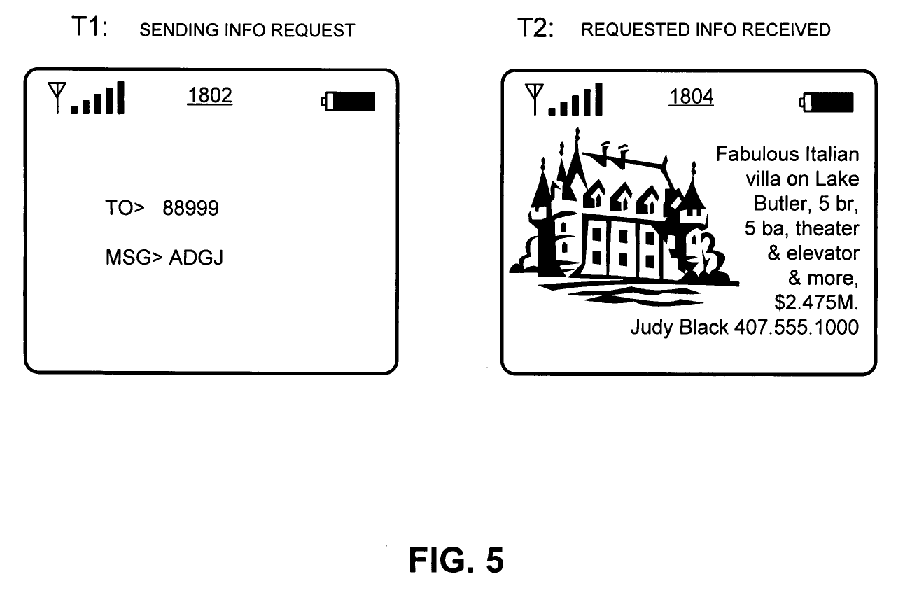

Referring now to FIG. 5, two typical mobile device screen views are presented according to one embodiment of the invention. After a potential customer sees a shortcode and a MAP keyword on or near a property in which he is interested, he constructs an SMS message similar to the one shown in screen view 1802. The message contains the shortcode 88999 as the receiver of the SMS message and the MAP keyword “ADGJ” as the message body. The SMS message is sent to the receiver as soon as the “SEND” button is pressed, as shown in time T1 in FIG. 5. At the time T2 of FIG. 5, the response to the information request is received by the customer's mobile device. The screen view 1804 is a message on the potential customer's mobile device showing a basic short text description of the property, the contact information, and possibly a picture of the property. This is just one example of the type of information that could be provides—with text and a still image. As will be appreciated by those skilled in the art, other multi-media information and methods can be used to provide relevant information to a potentially interested purchaser or renter of the property in question.

FIG. 6 is an abbreviated advertiser's order form for the WIPA system services according to one embodiment of the invention. This form comprises a fee schedule 602, customer's services requested area 604, a description of the services 606 and terms and condition of the services 608. The fee charged depends on the length of the service, the number of the MAP keywords ordered as shown in 602. After the advertiser enters the number of the MAP keywords ordered, and the length of the services, the total monthly service fee is automatically calculated and displayed on the screen as shown in 604. The description of the services 606 and the terms and the conditions are presented and the scroll bar on the right allows the advertiser to review the description of the services and the terms and conditions in their entirety. The advertiser is required to read and agree to the terms and the conditions of the WIPA services. The advertiser is required to check box 610 to indicate that the advertiser has read and agree to the terms and the conditions of the WIPA services. There are three buttons on the screen: a submit button 612 to submit the order form, a reset button 614 to start over again and a cancel button 616 to withdraw the order. Other useful information can be also included such as frequently asked questions (FAQs), the WIPA service contact information as shown in the “Contact Us”, about the WIPA service in “About”. A space to allow advertisers to join WIPA system's mailing list, detailed information brochure download, or directly link to the WIPA service representatives can also be offered in the screen as illustrated in FIG. 6.

FIG. 7 is an abbreviated advertiser's payment form for the WIPA system services according to one embodiment of the invention. This form comprises a summary of the requested services 702, a detailed payment methods and information sheet 704, in addition to other information similar to the information described in FIG. 6. The form 704 comprises detailed information for receiving the payment from the advertisers. The information is self explanatory and clearly shown in the drawing and is therefore not described in detail here. Similar to FIG. 6, other information is presented on the screen as in FIG. 6. There are three buttons on the screen: a submit button 706 to submit the order form, a reset button 708 to start over again and a cancel button 710 to withdraw the order.

Although the description of the above embodiment is mostly directed to the real estate market and to the advertising of sale or rent of real property, the invention is not limited by any means to real estate sale/purchases only. Sale or rental advertisements of other types of personally property and assets, such as automobiles, boats, furniture, and the like, can also benefit from this invention.

The foregoing description of the exemplary embodiments of the invention has been presented only for the purposes of illustration and description and is not intended to be exhaustive or to limit the invention to the precise forms disclosed. Many modifications and variations are possible in light of the above teaching.

Those persons skilled in the art will understand and appreciate that the sequence (s) and/or temporal order of the steps of the flow diagrams or processes described and claimed herein, are those considered to be the best mode for carrying out the present invention. It also should be understood that, although steps of various embodiments are shown and described in a particular sequence or temporal order, the steps are not limited to being carried out in any particular sequence or order, absent a specific indication that a step or steps should be carried out in a particular sequence or order to achieve a particular intended result. In most instances, the steps may be carried out in various different sequences and orders, while still falling within the scope of the present inventions.

Finally, the embodiments disclosed herein were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

1. A system for providing property information about a property over a wireless network to an interested party having a mobile device, comprising:
(i) an advertisement associated with the property, the advertisement having a shortcode and a keyword;
(ii) a networked computer system having a property database containing property information for the property; the property information being retrievable from the property database based on the shortcode and the keyword;
wherein, in operation, the interested party requests the property information about the property by sending a message with the shortcode and the keyword over the wireless network using the mobile device and, in response, the networked computer system retrieves the property information about the property associated with the shortcode and the keyword from the property database, and transmits the property information to the mobile device of the interested party.

2. The system of claim 1, wherein the networked computer system further comprises an electronic messaging platform having (a) a mobile client interface for establishing communications with the mobile device and (b) a message generator for generating at least one message having the property information for transmission to the mobile device.

3. The system of claim 1, wherein the networked computer system further comprises an administration platform having a web client interface and a web server for receiving property information for storage in the property database.

4. The system of claim 1, wherein the property information includes a URL link to an associated website having further information about the property.

5. The system of claim 1, wherein the property information includes information extracted from a multiple listing service.

6. The system of claim 1, wherein the keyword comprises a unique, three or more digit sequence of alphanumeric characters.

7. The system of claim 1, wherein an advertiser of the property is notified when the computer network system transmits the property information to the mobile device of the interested party.

8. The system of claim 7, wherein the notification to the advertiser is made in real time.

9. The system of claim 7, wherein the notification to the advertiser is made by text messaging, facsimile, email, voice mail, phone call, paging, regular mail, or posting on a web page associated with the computer network system.

10. The system of claim 1, wherein the networked computer system further comprises:
(i) an electronic messaging platform having (a) a mobile client interface for establishing communications with the mobile device and (b) a message generator for generating at least one message having the property information for transmission to the mobile device;
(ii) an administration platform having a web client interface and a web server for receiving property information for storage in the property database; and
(iii) a central processing system in communication with the property database, the electronic messaging platform, and the administration platform.

11. The system of claim 10, wherein the administration platform enables an advertiser of the property to register, enter, modify, remove and retrieve property information from the property database.

12. The system of claim 10, wherein the message is in an electronic format.

13. The system of claim 12, wherein the electronic format include one of SMS, MMS, WAP Push, WML, emails, and HTML pages.

14. The system of claim 10, wherein the message identifies additional ways to obtain further information about the property.

15. The system of claim 10, wherein the interested party requests further information by sending a reply to the message.

16. A method for providing property information about a property over a wireless network to an interested party having a mobile device, comprising the steps of:
(i) associating an advertisement with the property, the advertisement including a shortcode and a keyword;
(ii) storing property information about the property in a database;
(iii) associating the stored property information with the shortcode and the keyword;
(iv) receiving a message from the mobile device, the message including the shortcode and the keyword;
(v) retrieving the property information associated with the shortcode and the keyword from the database; and
(vi) transmitting the property information to the interested party's mobile device through the wireless network.

17. The method of claim 16 further comprising the step of receiving property information from an advertiser associated with the property.

18. The method of claim 16, wherein the keyword comprises a unique, three or more digit sequence of alphanumeric characters.

19. The method of claim 16, wherein the transmitting step further comprises the steps of providing the property information in an electronic format.

20. The method of claim 16, wherein the electronic format includes one of SMS, MMS, WAP Push, WML, emails, and HTML pages.

21. The method of claim 16, wherein the transmitting step further comprises the step of providing a URL link to an associated website having further information about the property.

22. The method of claim 16, wherein the transmitting step further comprises the step of identifying additional ways to obtain further information about the property.

23. The method of claim 16, wherein the transmitting step further comprises the step of providing property information extracted from a multiple listing service.

24. The method of claim 16, further comprising the step of notifying an advertiser of the property after a message regarding the property has been received from the mobile device.

25. The method of claim 24, wherein the step of notifying the advertiser is made in real time.

26. The method of claim 24, wherein the step of notifying the advertiser is made by text message, facsimile, email, voice mail, phone call, page, regular mail, or posting on a web page accessible by the advertiser.
